(19) United States
(12) Patent Application Publication
(10) Pub. No.: US 2002/0192118 A1
(43) Pub. Date: Dec. 19, 2002

(54) Microreactors

(76) Inventors: Torsten Zech, Heidelberg (DE); Bernhard Gutsche, Hilden (DE); Dieter Hoenicke, Karlsruhe (DE)

Correspondence Address: COGNIS CORPORATION, 2500 RENAISSANCE BLVD., SUITE 200, GULPH MILLS, PA, 19406

(21) Appl. No.: 10/076,736

(22) Filed: Feb. 15, 2002

(30) Foreign Application Priority Data
Feb. 15, 2001 (DE) DE 101 06 953.7

(51) Int. Cl. B01J 19/00

(52) U.S. Cl. 422/99; 422/130

(57) ABSTRACT

The invention relates to new microreactors consisting of at least one microreaction system applied to a carrier and comprising at least one microreaction space, at least one inlet for educts and at least one outlet for products, characterized in that the microreaction systems are rendered inert by a coating selected from the group consisting of silicon dioxide, silicon nitride and/or aluminium oxide.

### FIELD OF THE INVENTION

This invention relates generally to structural components for microreactions and more particularly to reactors in micro format which are distinguished by a new coating for avoiding or reducing unwanted reactions between the carrier or reactor material and the reactants.

### PRIOR ART

Microstructure reactors are known among experts to be microstructure apparatus for chemical processes of which the characteristic is that at least one of the three spatial dimensions of the reaction space is 1 to 2000 μm in size and which are therefore distinguished by a large transfer-specific inner surface, short residence times of the reactants and high specific heat and mass transport levels. Reference is made by way of example to European patent application EP 0903174 A1 (Bayer) which describes the liquid-phase oxidation of organic compounds in a microreactor consisting of a host of parallel reaction channels. Microreactors may additionally contain microelectronic components as integral constituents. In contrast to known microanalysis systems, there is no need in the case of microreactors for all lateral dimensions of the reaction space to be in the μm range. Instead, its dimensions are determined solely by the nature of the reaction. Accordingly, certain reactions may even be carried out in microreactors where a certain number of microchannels are grouped together so that microchannels and macrochannels or parallel operation of a plurality of microchannels can be present alongside one another. The channels are preferably disposed parallel to one another to achieve a high throughput and to minimize the pressure loss.

Unfortunately, microreactors often have the disadvantage that, due to their very large specific surface, unwanted reactions between the reactants and the carrier or reactor material can occur under reaction conditions, for example in the case of silicon as carrier or reactor material, which can lead to decomposition of the starting or target products.

Accordingly, the problem addressed by the present invention was to remedy this situation and to provide new microreactors designed in such a way that the carrier or reactor material would show completely or substantially inert behavior in the various zones and under the most diverse conditions.

### DESCRIPTION OF THE INVENTION

The present invention relates to new microreactors consisting of at least one microreaction system applied to a carrier and comprising at least one microreaction space, at least one inlet for educts and at least one outlet for products, characterized in that the microreaction systems are rendered inert (“inertized”) by a coating selected from the group consisting of silicon dioxide SiO₂, silicon nitride Si₃N and/or aluminium oxide Al₂O₃.

It has surprisingly been found that coating the carrier/reactor with the materials mentioned represents an effective way of suppressing or at least considerably reducing reactions between the carrier and various reactants under the most diverse conditions.

Carrier

The microreactors in which the structure and dimensions of the microreaction systems are determined in advance can represent combinations of materials such as, for example, silicon/silicon, glass/glass, metal/metal, metal/plastic, plastic/plastic or ceramic/ceramic or combinations thereof, even though the preferred embodiment is a silicon/glass composite. The structuring of a—for example—100 to 2000 μm and preferably about 400 μm thick wafer is preferably carried out by suitable microstructuring or etching techniques, for example reactive ion etching, by which three-dimensional structures can be produced in silicon irrespective of the crystal orientation [cf. James et al. in Sci. Am. 4, 248 (1993)]. The same treatment can also be applied, for example, to microreactors of glass. Wafers treated in this way can have 10 to 100, preferably 15 to 50 and more particularly 20 to 30 parallel microreaction systems which can be actuated and operated either in parallel or sequentially. The geometry, i.e. the two-dimensional character, of the channels can be very different and can include straight lines, curves, angles and the like and combinations of these geometric elements. Also, the microreaction systems do not all have to have the same geometry. The structures are distinguished by dimensions of 50 to 1500 μm and preferably 10 to 1000 μm and vertical walls, the depth of the channels being from 20 to 1800 μm and preferably from about 200 to 500 μm. The cross-sections of each microreaction space which can, but do not have to, be square are generally of the order of 20×20 to 1500×1500 μm² and more particularly of the order of 100×100 to 300×300 μm² which Burns et al. also describe as typical in Trans IChemE 77(5), 206 (1999). To supply the microreaction spaces with reactants, the wafer is etched through at the intended places.

Coating of the Carrier

After the microstructuring of a substrate, a compact “inertizing” layer is produced on the surface of the reaction spaces or channels. This layer should have a thickness of preferably 50 to 2,000, more preferably 100 to 1,000 and most preferably about 200 to 400 nm. The layer ensures that the educts or products do not interact with the surface of the carrier, more particularly a silicon wafer, so that there are none of the unwanted secondary or even decomposition reactions which are otherwise often observed. The thermal coating of a silicon wafer with SiO₂ is carried out by heating the wafer to ca. 1,000-1,100° C. in an oxygen-containing atmosphere (O₂, O₂ +HCl, H₂O). This leads to a reaction between silicon and oxygen which in turn produces an oxide layer over the entire exposed surface, i.e. in particular even in the channel microstructures. The thickness of the SiO₂ layer can be adjusted through the duration of the heat treatment and the oxidation conditions. The oxidation is a rooting process, i.e. the SiO₂ layer as it were grows into the wafer. The thicker the SiO₂ layer becomes during the process, the more slowly it grows because the oxygen has to diffuse through the SiO₂ layer formed for oxidation. The process is suitable for producing very compact SiO₂ layers whose adhesion is excellent because they are intergrown with the silicon. In addition, the wafer remains bondable, i.e. it can be bonded to other wafers, for example of glass or silicon. In general, other coating processes, for example chemical vapor deposition (CVD) for the production of, for example, SiO₂, Si₃N₄ and Al₂O₃ layers or even physical vapor deposition (PVD) and plasmachemical oxidation processes, are also suitable providing the material remains bondable. The choice of a suitable coating and coating technique is always made in dependence upon the chemical reaction to be carried out. Finally, the structured wafer rendered inert by coating is bonded to another wafer, for example of glass, preferably Pyrex glass, by a suitable process, for example anodic bonding, and the individual flow channels are tightly closed relative to one another. Depending on the substrate material, other buildup and joining techniques may of course also be used for producing sealed flow systems and are of course accessible to the expert without any need for inventive activity on his/her part.

Structuring of the Microreactors

The microreactors may be divided into one or more mixing zones, one or more reaction zones, one or more mixing and reaction zones, one or more heating and cooling zones or any combinations thereof. The microreactors reactor preferably have three zones, namely two reaction zones and one cooling zone, so that in particular two-stage or multi-stage liquid-phase or even gas-phase reactions can be efficiently investigated. Two reactants are mixed and reacted in the first zone, the reaction between the product of the first zone and another educt takes place in the second zone and the reaction is terminated in the third zone by lowering the temperature. It is not absolutely essential strictly to separate the first and second reaction zones thermally from one another. This is because, if another reactant has to be added or if several mixing points rather than one are required, this can be done beyond zone 1 in reaction zone 2. The microreaction systems can be operated sequentially or simultaneously, i.e. in parallel with defined quantities of educt. Another respect in which the microreaction systems can differ in their geometry is the mixing angle at which the educts impinge on one another and which can be between 15 and 270° and is preferably between 45 and 180°. In addition, each of the three zones can be cooled or heated independently of the others or the temperature in one of the zones can be varied, the reaction spaces in this example representing channels between 10 and 500 mm in length per zone.

### EXAMPLES

A microreactor consisting of a 400 μm thick silicon wafer bonded to a Pyrex glass wafer was used for the investigations. Twenty parallel, linear channels with a depth of 300 μm and a cross-section of the microreaction spaces of 300×300 μm² were etched into the silicon wafer. The silicon wafer was coated with a ca. 400 nm thick SiO₂ layer. The channels were operated in parallel and were etched through for educt delivery and product removal. The formation of performic acid by the action of hydrogen peroxide on formic acid was investigated. The comparison investigations were carried out with a microreactor of the same kind but without the coating. The results are set out in Table 1. Examples 1 to 8 correspond to the invention, Examples C1 to C6 are intended for comparison.

TABLE 1
Oxidation of formic acid*)

| | Composition of reaction system | | | | | |
|---|---|---|---|---|---|---|
| | HCOOH | H₂O₂ | Water | T | t | |
| Ex. | % By weight | % by weight | % by weight | ° C. | h | Result |
| C1 | 0 | 60 | 40 | 25 | 24 | No loss of weight, |
| | | | | | | no surface change |
| C2 | 10 | 15 | 75 | 25 | 48 | No loss of weight, |
| | | | | | | no surface change |
| C3 | 0 | 60 | 40 | 50 | 24 | Gas bubbles adhere to the |
| | | | | | | Si wafer in the channels |
| C4 | 0 | 60 | 40 | 50 | 48 | Gas bubbles adhere to the |
| | | | | | | Si wafer in the channels |
| C5 | 10 | 15 | 75 | 50 | 24 | Vigorous effervescence, |
| | | | | | | decomposition of per acid |
| C6 | 10 | 15 | 75 | 50 | 48 | Vigorous effervescence, |
| | | | | | | decomposition of per acid |
| 1 | 0 | 60 | 40 | 25 | 24 | No loss of weight, |
| | | | | | | no surface change |
| 2 | 0 | 60 | 40 | 25 | 48 | No loss of weight, |
| | | | | | | no surface change |
| 3 | 0 | 60 | 40 | 50 | 24 | No loss of weight, |
| | | | | | | no surface change |
| 4 | 0 | 60 | 40 | 50 | 48 | No loss of weight, |
| | | | | | | no surface change |
| 5 | 10 | 15 | 75 | 25 | 24 | No loss of weight, |
| | | | | | | no surface change |
| 6 | 10 | 15 | 75 | 25 | 48 | No loss of weight, |
| | | | | | | no surface change |
| 7 | 10 | 15 | 75 | 50 | 24 | No loss of weight, |
| | | | | | | no surface change |
| 8 | 10 | 15 | 75 | 50 | 48 | No loss of weight, |
| | | | | | | no surface change |

*) Tests C1, C3, C4 and 1 to 4 were carried out with 30% by weight H₂O₂. In every other case, the concentration was 100% by weight

1. Microreactors consisting of at least one microreaction system applied to a carrier and comprising at least one microreaction space, at least one inlet for educts and at least one outlet for products, characterized in that the microreaction systems are rendered inert by a coating selected from the group consisting of silicon dioxide, silicon nitride and/or aluminium oxide.

2. Microreactors as claimed in claim 1, characterized in that the carrier is a silicon/glass composite.

3. Microreactors as claimed in claims 1 and/or 2, characterized in that the microreaction systems are applied by suitable microstructuring techniques.

4. Microreactors as claimed in at least one of claims 1 to 3, characterized in that they comprise 10 to 100 parallel microreaction systems.

5. Microreactors as claimed in at least one of claims 1 to 4, characterized in that the inertizing layer is compact and has a thickness of 50 to 2,000 nm.

6. Microreactors as claimed in at least one of claims 1 to 5, characterized in that, in at least one spatial dimension, the reaction spaces are 50 to 1500 μm in size.

7. Microreactors as claimed in at least one of claims 1 to 6, characterized in that the reaction spaces have a depth of 20 to 1800 μm.

8. Microreactors as claimed in at least one of claims 1 to 7, characterized in that the reaction spaces have cross-sections of 20×20 to 1500×1500 μm².

9. Microreactors as claimed in at least one of claims 1 to 8, characterized in that the reaction spaces are channels and have a length of 1 to 500 mm.

10. Microreactors as claimed in at least one of claims 1 to 9, characterized in that the reaction spaces comprise one or more mixing zones, one or more reaction zones, one or more mixing and reaction zones, one or more heating and cooling zones or any combinations thereof.
